(19) United States
(12) Patent Application Publication
(10) Pub. No.: US 2011/0142457 A1
(43) Pub. Date: Jun. 16, 2011

(54) INTEGRATED TRANSMIT AND RECEIVE MODULES FOR A COHERENT OPTICAL TRANSMISSION SYSTEM

(75) Inventors: Ian BETTY, Ottawa (CA); Kim B. ROBERTS, Nepean (CA); Christopher KUROWSKI, Nepean (CA)

(73) Assignee: NORTEL NETWORKS LIMITED, St. Laurent (CA)

(21) Appl. No.: 12/721,876

(22) Filed: Mar. 11, 2010

Related U.S. Application Data
(60) Provisional application No. 61/286,316, filed on Dec. 14, 2009.

(51) Int. Cl. H04B 10/06; G02B 6/12

(52) U.S. Cl. 398/214; 385/14

(57) ABSTRACT

An integrated optical package includes a package mount including a plurality of electrical connectors. A digital electronic integrated circuit (IC) is electrically connected to the electrical connectors of the package mount via a first set of solder balls or bumps. An optical IC includes optical waveguide traces and one or more electrical contact points for electrically coupling the optical IC to the digital electronic IC via a second set of solder balls or bumps. One or more optical fibre pig-tails optically coupled to the optical waveguide traces of the optical IC.

### CROSS-REFERENCE TO RELATED APPLICATIONS

This application is based on, and claims benefit of Provisional U.S. Patent Application Ser. No. 61/286,316 filed Dec. 14, 2009.

### MICROFICHE APPENDIX

Not Applicable.

### TECHNICAL FIELD

The present invention relates generally to optical transmitter and receiver modules, and in particular to integrated transmit and receive modules for a coherent optical transmission system.

### BACKGROUND

FIGS. 1a and 1b respectively illustrate optical transmit and receive modules of a type typically used in coherent optical transmission systems. Referring to FIG. 1a, a transmit module 2 typically comprises a connector 4, digital driver 6, analog driver 8, and an optical modulator 10, all of which are mounted on a printed circuit board (PCB) substrate 12. The connector 4 is typically a multi-pin connector which enables digital data signals to be supplied to the module 2 for transmission, as well as electrical power supply and ground connections for the digital and analog drivers. The digital driver 6 is typically provided as a digital signal processor, for computing digital driver signals based on the received digital data signals. For example, the digital driver 6 may process the received digital data signals to implement an encoding scheme such as Phase Shift Keying (PSK), so that the digital drive signals will take the form of encoded symbols. More complex signal processing functions may be implemented as desired. The Analog driver 8 comprises digital-to-analog converters (DACs) and analog signal conditioning circuits (such as power amplifiers, and filters) for converting the digital diver signals into analog driver signals that are suitable for driving the modulator 10. The modulator 10, which may, for example, be a Mach-Zehnder modulator) receives a narrow-band optical carrier from a laser 14, and outputs a modulated optical channel signal based on the analog driver signals. In the illustrated embodiment, the laser 14 is located remotely from the transmit module 2, and the narrow-band optical carrier is supplied to the modulator 10 via an input optical fibre “pig-tail” 16. The modulated optical channel signal output by the modulator 10 is directed to downstream optical devices (such as optical multiplexers etc., not shown) via an output optical fibre pig-tail 18.

Referring to FIG. 1b, a receiver module 20 typically comprises an optical hybrid 22, photodetector array 24, analog receiver stage 26, digital signal processor 28, and a connector 30, all of which are mounted on a PCB substrate 32. The optical hybrid 22 receives an input optical channel signal through an optical fibre pig-tail 34 connected to upstream optical devices (such as an optical de-multiplexer, not shown) and light from a local oscillator 36 via a respective LO pig-tail 38. The photodetector array receives mixed light from the optical hybrid, and outputs corresponding analog electrical signals. The analog receiver stage comprises analog signal conditioning circuits (such as power amplifiers, filters etc.) and analog-to-digital converters (ADCs) for converting the analog electrical signals from the photodetectors into raw digital signals which are processed by the DSP to detect and recover digital data signals from the raw digital signals. The connector is typically a multi-pin connector which enables recovered digital data signals output from the DSP to be supplied to further data recovery and processing systems, as well as electrical power supply and ground connections for the photodetector array, analog receiver stage, and the DSP.

In both of the transmit and receive modules described above, the PCB substrate provides both a structural support for each of the other elements of the module, and the electrical interconnections between them. In the case of the transmit module (FIG. 1a), a digital data bus is provided between the connector and the digital driver, which is designed to carry data signal traffic at the intended bit-rate; a high-speed digital interface is provided between the digital driver and the analog driver, for conveying digital signals at a desired sample rate. Finally, an analog bus is provided for carrying the (typically radio frequency) analog drive signals from the analog driver to the modulator. In the case of the receive module (FIG. 1b), the optical hybrid and photodetector array are optically connected via optical waveguides which are often supported independently of the PCB substrate. However, an analog bus is provided for carrying the (typically radio frequency) analog signals from the photodetector array to the analog receiver stage. A high-speed digital interface is provided between the analog receiver stage and the DSP, for conveying the raw digital signals at the ADC sample rate. Finally, a digital data bus is provided between the DSP and the connector, which is designed to carry recovered data signal traffic at the intended bit-rate.

Typically, the various active components of the transmit and receive modules are provided as separate elements, which are assembled together on the PCB substrate, for example using known surface mounting techniques. This arrangement enables each of these components to be separately manufactured (e.g. by different manufacturers) which increases the design freedom in selecting components for each module, and reduces costs.

However, this arrangement suffers a disadvantage in that the impedance of the electrical interconnections on the PCB substrate means that each of the active components (principally the digital and analog drivers on the transmit module, and the analog receiver stage and the DSP on the receiver module) must have suitable impedance-matching and power-driver circuits in order to interface with the PCB. This increases both the cost and power consumption of each of these devices, as well as presenting an additional source of noise. The severity of these problems tends to increase rapidly with increases in either data signal bit rates and complexity of the digital signal processing implemented by the digital driver and DSP components.

Techniques for assembling transmit and receive modules that overcome limitations of the prior art remain highly desirable.

### SUMMARY

Accordingly, an aspect of the present invention provides an integrated optical package includes a package mount including a plurality of electrical connectors. A digital electronic integrated circuit (IC) is electrically connected to the electrical connectors of the package mount via a first set of solder balls or bumps. An optical IC includes optical waveguide traces and one or more electrical contact points for electrically coupling the optical IC to the digital electronic IC via a second set of solder balls or bumps. One or more optical fibre pig-tails optically coupled to the optical waveguide traces of the optical IC.

### BRIEF DESCRIPTION OF THE DRAWINGS

Representative embodiments of the invention will now be described by way of example only with reference to the accompanying drawings, in which:

FIGS. 1a and 1b respectively illustrate principal elements of transmit and receive modules known in the art;

FIGS. 2a and 2b are perspective and cross-section view, respectively, showing principal elements of an integrated transmit module in accordance with a representative embodiment of the present invention;

FIG. 3 is a top view showing principal elements of a modulator IC usable in the integrated transmit module of FIG. 2; and

FIG. 4 is a perspective view showing principal elements of an integrated receiver module in accordance with a representative embodiment of the present invention; and

FIG. 5 is a top view showing principal elements of a receiver IC usable in the integrated receive module of FIG. 4.

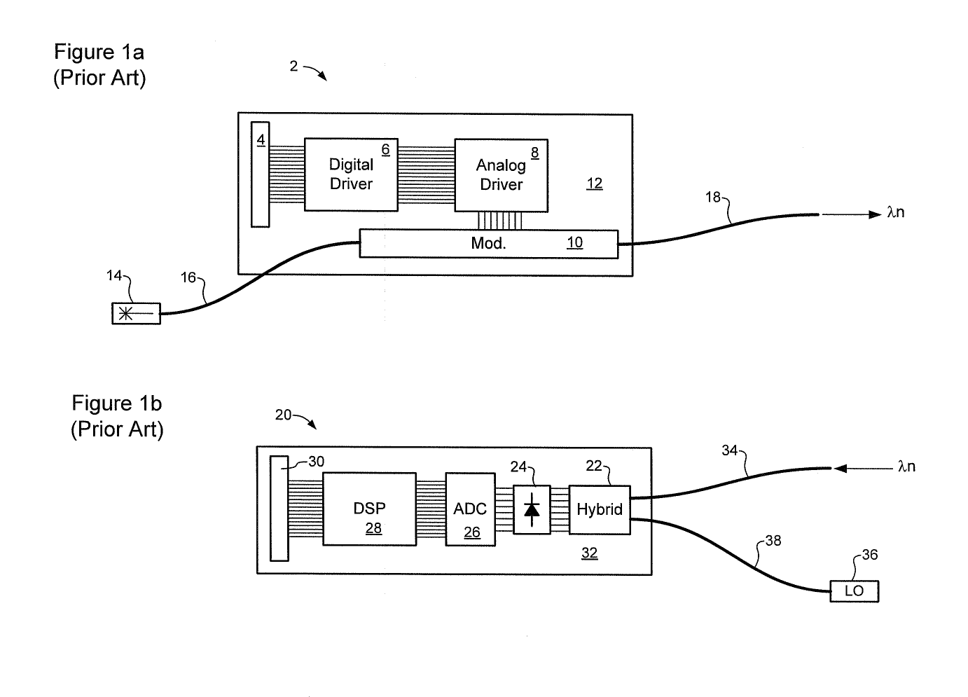

It will be noted that throughout the appended drawings, like features are identified by like reference numerals.

### DETAILED DESCRIPTION OF PREFERRED EMBODIMENTS

In very general terms the present invention provides an integrated optical package comprising a digital electronic integrated circuit (IC) coupled to an optical IC. The IC assembly is supported on a ceramic package mount, which also provides an electrical connection between the digital electronic IC and an external printed circuit board, such as a line card. Optical signals are conducted into and out of the integrated optical package using optical fibre pig-tails that are optically coupled to the optical IC, and mechanically supported by the package housing. This provides an optical package that can be handled and mounted on an external printed circuit board, in a manner closely similar to a conventional IC package. In some cases, standard socket mounts can be used.

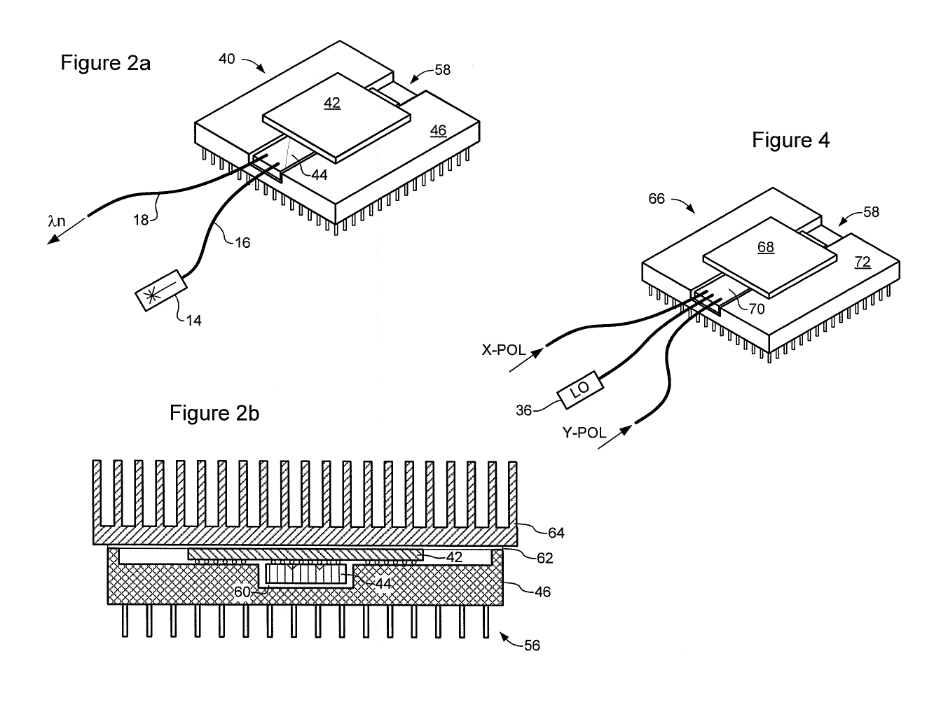

Referring to FIGS. 2a and 2b, there is shown an integrated transmit module 40 in accordance with a representative embodiment of the present invention. In the embodiment of FIG. 2, the integrated transmit module 40 comprises a digital electronic driver IC 42 electrically bonded to an integrated optical modulator IC 44 and a ceramic package mount 46.

The driver and modulator ICs may be configured as described in applicant's U.S. Pat. No. 7,277,603, which issued Oct. 2, 2007. Thus, the driver IC can be provided as a Complementary Metal Oxide Semiconductor (CMOS) digital IC manufactured using known methods. Similarly, the modulator IC can be manufactured using known methods. Importantly, both ICs should be manufactured using the same materials so as to avoid mechanical stresses in the connection between the two IC, due to differential thermal expansion rates. Silicon is a convenient material choice because well known techniques can be used for manufacturing both of the driver and modulator ICs. Furthermore, known techniques may be used to align and attach optical fibre pigtails to the modulator IC manufactured using silicon. Other materials, such as Indium-Phosphide (InP) or Galium-Arsenide (GaAs) may be used to construct the driver and modulator ICs, if desired.

In the illustrated embodiment, the driver and modulator ICs are manufactured separately, and the two chips electrically connected using solder balls or bumps 48 in a manner known in the art. This arrangement is convenient in that it facilitates the use of different fabrication processes (and even different manufacturers) to manufacture the two ICs.

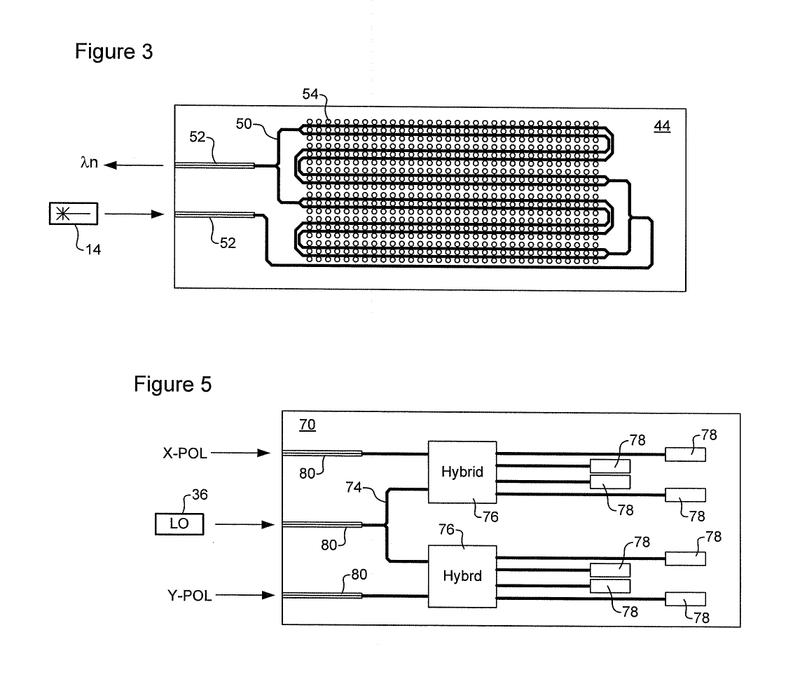

Preferably, the modulator IC 44 is constructed to provide the optical waveguide traces 50 (FIG. 3), and the finger contacts (not shown) required to define the optical modulator, as well as v-grooves 52 for aligning fiber optic pigtails 16,18 with respective opposite ends of the waveguide traces 50. In some cases, the optical waveguide traces 50 may follow a circuitous route across the modulator IC, as may be seen in FIG. 3. The modulator IC 44 may not contain any logic gates, buffers, or other electrical signal processing components. Rather, the upper surface of the modulator IC 44 merely presents an array or grid of electrical contact points 54, which facilitate electrical connection with circuit traces on the driver IC 42 via solder balls or bumps. On the other hand, the modulator IC 44 may include various optical signal processing devices (such a variable optical attenuators, etc, not shown) which may be also be controlled by the driver IC via suitable contact points. Advantageously, this arrangement results in a large number of solder balls between the modulator and diver ICs, which serves to both mechanically secure the two ICs together and provide the necessary electrical connections between the circuit traces of the driver IC and the contacts of the modulator IC.

As described in U.S. Pat. No. 7,277,603, an advantage of a modulator IC constructed as described above is that the finger contacts of the modulator IC present a capacitive load to the driver IC, which can be driven directly from CMOS circuits of the digital driver IC. This arrangement eliminates the need for an analog driver stage between the driver and modulator ICs.

As may be seen in FIG. 2b, the ceramic package mount 48 comprises a pin connector assembly 56 which enables the transmit module 40 to be electrically connected to a line card (not shown) which provides electrical power and ground supplies, as well as data signals for transmission. The driver IC 42 can be electrically connected to the pin connector assembly 56 of the ceramic package mount 46 by means of solder balls or bumps. In some cases, these solder balls (bumps) may also mechanically secure the driver IC to the ceramic package mount.

In the illustrated embodiment, the ceramic package mount includes a trough 58 sized to receive the modulator IC. If desired, a gap 60 between the modulator IC 44 and the ceramic package mount 46 may be filled with a potting compound, such as, for example, epoxy. An advantage of this arrangement is that it enables the driver IC 42 to be designed with all of its electrical connections (with both the modulator IC and the ceramic package mount) on one face of the IC. This leaves the opposite face free of electrical components, and thereby facilitates attachment of a package lid 62 and a heat-sink 64.

Referring to FIGS. 4 and 5, an integrated receiver module 66 in accordance with the present invention can be constructed in an analogous manner to the transmit module of FIG. 2. In this case, the integrated receiver module 66 comprises a digital electronic signal processor (DSP) IC 68 electrically bonded to an integrated optical receiver IC 70 and a ceramic package mount 72. In the illustrated embodiment, the receiver IC 70 is constructed to provide optical waveguide traces 74 (FIG. 5) required to define a pair or parallel 90° optical hybrids 76, and to conduct the resulting mixed light to a set of balanced photodiodes 78. A set of v-grooves 80 are also provided for aligning a respective fiber optic pigtail with each of the waveguide traces. With this arrangement, a received optical wavelength channel can be split into respective X- and Y-Polarizations by a polarization beam-splitter (not shown), each of which can be mixed with local oscillator light and the mixed light made incident on the photodiodes 78.

As with the modulator IC described above, the receiver IC 70 preferably does not include any logic gates, buffers, or other electrical signal processing components. Rather, the upper surface of the receiver IC merely presents a set of electrical contact points, which facilitate electrical connection between the photodiodes and appropriate circuit traces on the DSP IC 68 via solder balls or bumps. On the other hand, the receiver IC 70 may include various optical signal processing devices, such as variable optical attenuators, optical power taps, polarization beam splitters etc, which may be also be controlled by the DSP IC 68 via suitable contact points. In this case, it is possible that the number of solder connections between the receiver and DSP ICs may by insufficient to provide a satisfactory mechanical connection between the two chips. In this case, a potting compound (e.g. epoxy) may be required within the trough 58 of the ceramic package mount 72 in order to support the receiver IC. Alternatively, a plurality of “dummy bumps” (that is, solder balls or bumps that provide a mechanical connection but no electrical connection) may be provided to strengthen the mechanical connection between the receiver and DSP ICs and thereby ensure that the receiver IC 70 has sufficient mechanical support,

In some embodiments, the solder balls (or bumps) used to connect the optical IC to the digital electronic IC are formulated to have a higher melting temperature than those used to connect the digital electronic IC to the ceramic package mount. This arrangement enables the electronic and optical ICs to be precisely aligned and attached (both mechanically and electrically) by heating to the melting temperature of the solder balls, and then cooling. The IC electronic IC can subsequently be attached to the ceramic package mount by aligning the electronic IC with the contacts of the ceramic package mount, and then heating to the melting temperature of the package solder balls, and then cooling. Because the solder balls used to secure the optical IC have a higher melting temperature, the electronic IC can be attached to the ceramic package mount without damaging the connection(s) between the optical and electronic ICs.

Although the invention has been described with reference to certain specific embodiments, various modifications thereof will be apparent to those skilled in the art without departing from the spirit and scope of the invention as outlined in the claims appended hereto.

We claim:

1. An integrated optical package comprising:
a package mount including a plurality of electrical connectors;
a digital electronic integrated circuit (IC) electrically connected to the electrical connectors of the package mount via a first set of solder balls or bumps;
an optical IC including optical waveguide traces and one or more electrical contact points for electrically coupling the optical IC to the digital electronic IC via a second set of solder balls or bumps; and
one or more optical fibre pig-tails optically coupled to the optical waveguide traces of the optical IC.

2. The integrated optical package as claimed in claim 1, wherein the digital electronic IC is a driver IC and the optical IC is an optical modulator for modulating an optical carrier light in accordance with drive signals generated by the driver IC.

3. The integrated optical package as claimed in claim 1, wherein the optical IC is an optical receiver for supplying a received light to one or more photodetectors, and the digital electronic IC is a digital signal processor for processing electrical signals output from the photodetectors of the optical receiver to detect a received data signal.

4. The integrated optical package as claimed in claim 1, wherein a melting temperature of the first set of solder balls or bumps is lower than that of the second set of solder balls or bumps.
